(19) United States
(12) Patent Application Publication
(10) Pub. No.: US 2011/0148017 A1
(43) Pub. Date: Jun. 23, 2011

(54) ADJUSTING DEVICE FOR ADJUSTING STIFFNESS THEREOF

(75) Inventors: JIUN-YIH KUAN, Taipei (TW); Han-Pang Huang, Taipei (TW)

(73) Assignee: National Taiwan University, Taipei (TW)

(21) Appl. No.: 12/769,987

(22) Filed: Apr. 29, 2010

(30) Foreign Application Priority Data
Dec. 17, 2009 (TW) 98143455

(51) Int. Cl. F16F 1/06

(52) U.S. Cl. 267/166

(57) ABSTRACT

The present invention provides an adjusting device. It is used a adjusting unit to be set in advance if a stiffness demanded is known and to adjust appropriately if the stiffness demanded is unknown or changed. A changed stiffness system which can be actively or passively adjusted can be achieved by the adjusted device. Based on the above conception, the adjusting device includes a first resilient unit and the adjusting unit, wherein the first resilient unit has a characteristic gap between one end thereof and the adjusting unit. In addition, the adjusting device further includes a connecting resilient unit, wherein the length thereof is a sum of lengths of the first resilient unit and the characteristic gap. It is the present invention to adjust the length of the characteristic gap by the adjusting unit to adjust the stiffness of the adjusting device.

### FIELD OF THE INVENTION

The invention is related to an adjusting device, more particularly to an adjusting device for actively or passively adjusting the stiffness thereof.

### BACKGROUND OF THE INVENTION

While the traditional mechanism system can only perform the positioning control during magnifying the output force and can not keep the power steady without sensors for detecting the external force, the mechanism with the flexibility has the advantages of controlling power, decreasing the possibility of the damage of the input power source and protecting the operation environment for users. In addition, when the power control system is failed or the component behavior can not be predicted immediately by the control system, the mechanism designed with flexibility is capable to keep the system safe in operation.

For example, the mechanism designed with flexibility utilizes with at least one elastic element in series as disclosed in U.S. Pat. No. 5,650,704. However, since the stiffness of the mechanism is constant and can not be changed after finishing the fabrication, the stiffness and the deformation property thereof can not be adjusted. Therefore, the mechanism can not satisfy both demands of the operation performance and safety at the same time in different environments so that the operation of the mechanism is limited and can not be extensively applied for a specific task.

FIG. 1 schematically illustrates a mechanism with changeable stiffness in the prior art. The mechanism includes a first spring 10 with a first spring constant k₁ and a second spring 11 with a second spring constant k₂. Due to the original length difference d between the first spring 10 and the second spring 11, the force-deformation curve is not a simple line. When the second spring 11 is compressed under the condition of low load, the stiffness of the mechanism is k₂. When the first spring 10 and the second spring 11 would be compressed simultaneously to change the stiffness under the condition of high load if the deformation of the second spring 11 is longer than the original length difference d, the stiffness of the mechanism is k₁+k₂. Although the force-deformation curve is not a simple line, the original length difference d is constant so that there are only two values of stiffness to be chosen. Since the original length difference d can not be changed after finishing the fabrication, the stiffness and the deformation property can not be correspondingly adjusted for any different conditions.

Therefore, to overcome the drawbacks from the prior art and to meet the present needs, the Applicant dedicated in considerable research, and finally accomplishes the “adjusting device for adjusting the stiffness thereof” of the present invention, wherein the adjusting device can actively or passively adjust the relative position of the plurality of resilient units for difference environments and the specific tasks to achieve the optimum performance so as to overcomes the above drawbacks. The present invention is briefly described as follows.

### SUMMARY OF THE INVENTION

The present invention provides an adjusting device to be set in advance if a stiffness demanded is known and to be adjusted appropriately if the stiffness demanded is unknown or changed so that the stiffness thereof can be actively or passively adjusted.

Based on the above conception, there is an adjusting system with a least one characteristic gap, including: a first unit, a second unit, at least one resilient unit having a first end coupled to one of the first and the second units and a second end, wherein the at least one characteristic gap is a distance between the second end and the other one of the first and the second units, and an adjusting unit configured to adjust the at least one resilient unit to change the at least one characteristic gap.

Preferably, the first unit is an input unit and the second unit is an output unit.

Preferably, the adjusting unit is connected with the at least one resilient unit.

Preferably, the adjusting unit further includes a movable unit and a force controller connected with the movable unit.

Preferably, the movable unit is configured to adjust the at least one characteristic gap by a force provided from the force controller.

Preferably, the at least one resilient unit is one of a spring and a nonlinear resilient body.

Preferably, the nonlinear resilient body further includes a spring and a four-bar mechanism, the spring is connected with the four-bar mechanism, and a force direction of the spring is intersected with a force direction of the nonlinear resilient body.

Preferably, the adjusting unit is configured to adjust a stiffness of the adjusting system.

Preferably, the adjusting system further includes a connecting resilient unit connecting the first and the second units.

Based on the above conception, there is an actuator with a plurality of characteristic gaps, including: a plurality of resilient units, each of which has two ends and a respective characteristic gap outside one end thereof and a plurality of adjusting units, each of which adjusts at least a respective one of the plurality of characteristic gaps.

Preferably, the actuator further includes a power input unit connecting one end of each the resilient units.

Preferably, the actuator further includes a power output unit connecting one end of each the resilient units.

Preferably, the actuator further includes a plurality of power input units, each of which connects one end of the at least one respective resilient units.

Preferably, the actuator further includes a plurality of power output units, each of which connects one end of the at least one respective resilient units.

Preferably, each of the plurality of adjusting units further includes a movable unit and a force controller connected with the movable unit.

Preferably, the movable unit is configured to adjust at least one respective characteristic gap by a force provided from the force controller.

Preferably, at least one of the plurality of characteristic gaps has a length larger than zero.

Based on the above conception, there is an adjusting device coupled between two units, including: a resilient unit having a first end connecting one of the two units and a second end, wherein between the second end and the other one of the two units, there is a characteristic gap, and an adjusting unit adjusting the characteristic gap.

Preferably, the adjusting device further includes a movable unit configured to carry thereon the adjusting unit.

Preferably, the adjusting device further includes a connecting resilient unit connecting the two units, and having a length being a sum of lengths of the resilient unit and the characteristic gap.

### BRIEF DESCRIPTION OF THE DRAWINGS

FIG. 1 is a diagram which schematically illustrates a mechanism with changeable stiffness in the prior art;

FIG. 2 is a diagram which schematically illustrates an adjusting device according to the basic structure of the present invention;

FIG. 3(a) is a diagram which schematically illustrates an adjusting system without providing any force according to a first preferred embodiment of the present invention;

FIG. 3(b) is a diagram which schematically illustrates the adjusting system with a first preset deformation according to a first preferred embodiment of the present invention;

FIG. 3(c) is a diagram which schematically illustrates the adjusting system with a second preset deformation according to a first preferred embodiment of the present invention;

FIG. 3(d) is a diagram schematically illustrates a force-deformation curve according to a first preferred embodiment of the present invention;

FIG. 4 is a diagram which schematically illustrates the adjusting system 4 without providing any applied force according to a second preferred embodiment of the present invention;

FIG. 5 is a diagram which schematically illustrates the adjusting device 5 without providing any applied force according to a third preferred embodiment of the present invention;

FIG. 6 is a diagram which schematically illustrates the adjusting device 6 without providing any applied force according to a forth preferred embodiment of the present invention;

FIG. 7 is a diagram which schematically illustrates the four-bar mechanism;

FIG. 8 is a diagram which schematically illustrates the adjusting system without providing any applied force according to a fifth preferred embodiment of the present invention;

FIG. 9 (a) is a diagram which schematically illustrates the actuator without providing any applied force according to sixth preferred embodiments of the present invention; and

FIG. 9 (b) is a diagram which schematically illustrates the actuator without providing any applied force according to seventh preferred embodiments of the present invention.

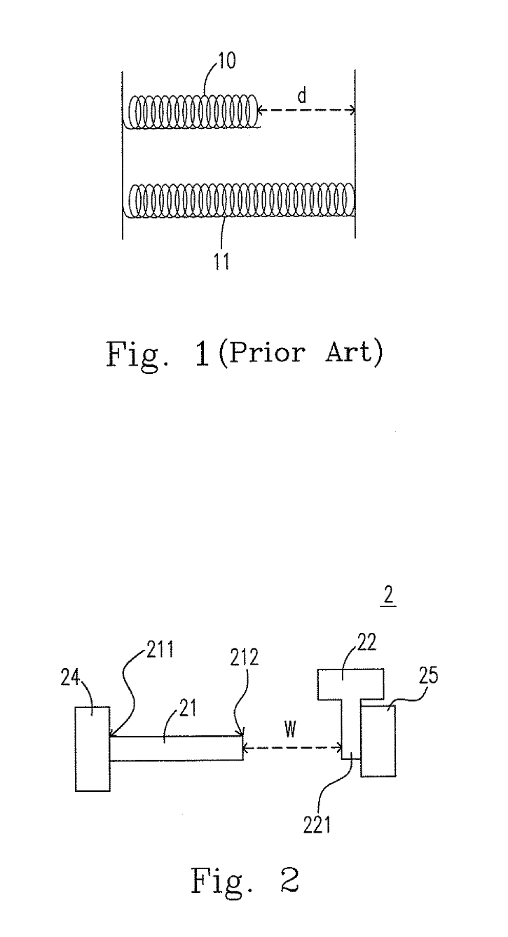

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intend to be exhaustive or to be limited to the precise form disclosed.

Moreover, in order to provide clearer descriptions more easily understood the present invention, the parts of the drawing do not draw in accordance with their relative sizes. Some sizes and scales have been exaggerated or magnified. The parts of unrelated details are not drawn completely to simplify the drawing.

FIG. 2 schematically illustrates an adjusting device 2 according to the basic structure of the present invention. The adjusting device 2 is coupled between two units 24, 25, wherein the two units 24, 25 are respectively an input unit 24 and an output unit 25, and includes a resilient unit 21 with constant stiffness having a first end 211 connecting the input unit 24 and a second end 212, wherein there is a characteristic gap W between the second end 212 and the output unit 25, and an adjusting unit 22 for adjusting the characteristic gap W. The adjusting unit 22 includes a movable unit 221 configured to carry the adjusting unit 22 for adjusting the length of the characteristic gap W which can be changed by moving the position thereof, wherein the order of the characteristic gap W, the adjusting unit 22, and the resilient unit 21 can be arbitrarily changed, and the input unit 24 can be interchanged with the output unit 25.

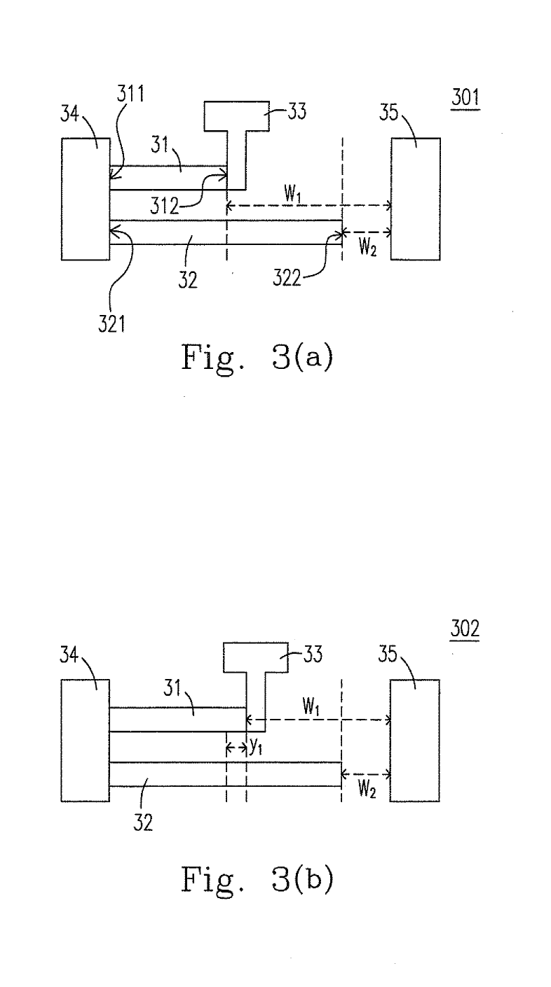

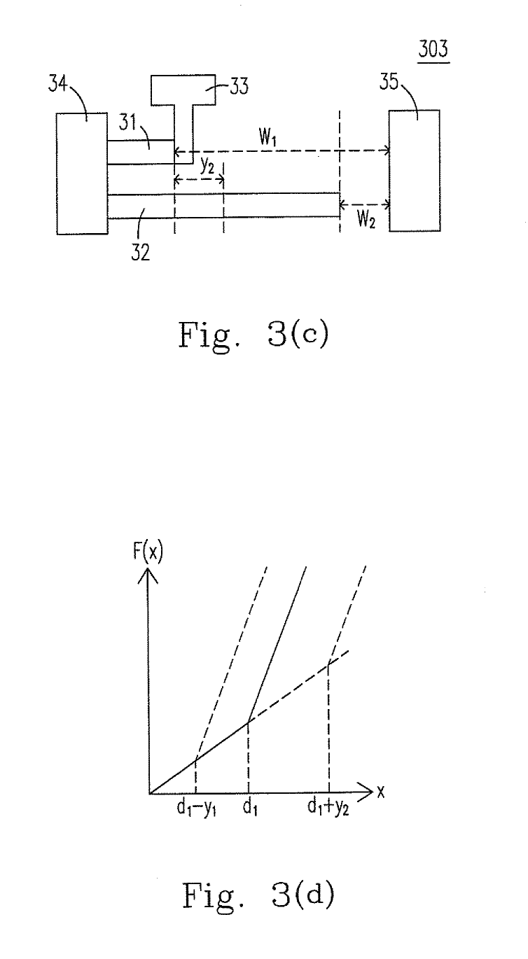

FIG. 3(a) schematically illustrates an adjusting system 301 without providing any force according to a first preferred embodiment of the present invention. The adjusting system 301 includes a first resilient unit 31 with a first stiffness k₁, a second resilient unit 32 with a second stiffness k₂, a first unit 34, a second unit 35, an adjusting unit 33, a first characteristic gap W₁ having a first original length d₁ and a second characteristic gap W₂ having a second original length d₂, wherein the first stiffness k₁ and the second stiffness k₂ are constants. Moreover, the first resilient unit 31 has a first end 311 connecting with the first unit 34 and second end 312 and the second resilient unit 32 has a third end 321 connecting with the first unit 34 and a forth end 322, wherein there is a first characteristic gap W₁ existing between the second end 312 and the second unit 35 and there is a second characteristic gap W₂ existing between the forth end 322 and the second unit 35. In addition, the adjusting unit 33 is connected with the first resilient unit 31 to adjust the first characteristic gap W₁. Furthermore, the first unit 34 and the second unit 35 respectively are an input unit and an output unit and can be interchanged. When an applied force is applied to the adjusting system 301, a length of the second characteristic gap W₂ is directly changed until zero since there is nothing in the second characteristic gap W₂ so that the applied force is directly applied to the second resilient unit 32. If a deformation x induced by the applied force is shorter than the first original length d₁, a length of the first characteristic gap W₁ would be decreased, but not zero. Therefore, the applied force could not be applied to the first resilient unit 31 so that an output force would not be provided from the first resilient unit 31. Consequently, the output force would be only provided from the second resilient unit 32 because of the second characteristic gap W₂ being zero so that the applied force is k₂(x−d₂). If the deformation x induced by the applied force is longer than the first original length d₁, the output force could be provided from the first resilient unit 31 and the second resilient unit 32 since the first characteristic gap W₁ and the second characteristic gap W₂ would be changed until zero. Furthermore, the applied force becomes k₂(x−d₂) k₁(x−d₁) at that time and consequently, a force to change stiffness is k₂×d₁.

FIGS. 3(b) and (c) schematically illustrate the adjusting system 302 and 303 without providing any applied force according to a first preferred embodiment of the present invention. The first resilient unit 31 is stretched in advance to form a first preset deformation y₁ in FIG. 3(b) by an internal force provided from the adjusting unit 33, wherein y₁ is shorter than d₁−d₂. When an applied deformation induced by the applied force is longer than d₁−y₁, the output force would be provided from the first resilient unit 31 and the second resilient unit 32 so that the force to change stiffness is decreased to be read as k₂(d₁−y₁). The first resilient unit 31 is compressed in advance to form a second preset deformation y₂ in FIG. 3(c) by an internal force provided from the adjusting unit 33, wherein y₂ is shorter than the first original length d₁. When the applied deformation induced by the applied force is longer than d₁+y₂, the output force would be provided from the first resilient unit 31 and the second resilient unit 32 so that the force to change the stiffness is increased to be read as k₂(d₁+y₂).

FIG. 3(d) is a diagram of a force-deformation curve according to a first preferred embodiment of the present invention. When the internal force is not provided from the adjusting unit 33, the output force would be induced from the first resilient unit 31 and the second resilient unit 32 if the applied deformation is longer than the first original length d₁. When the first resilient unit 31 is stretched in advance to form the first preset deformation y₁, the output force would be induced from the first resilient unit 31 and the second resilient unit 32 if the applied deformation is longer than d₁−y₁. When the first resilient unit 31 is compressed in advance to form the second preset deformation y₂, the output force would be induced from the first resilient unit 31 and the second resilient unit 32 if the applied deformation is longer than d₁+y₂. Consequently, the stiffness of the adjusting system can be adjusted by the adjusting unit 33.

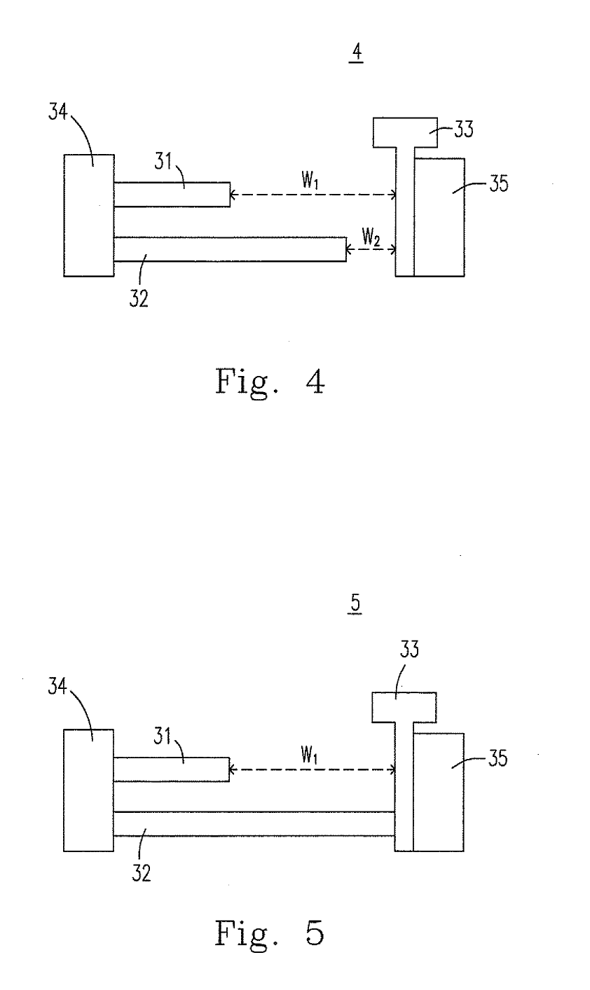

FIG. 4 schematically illustrates the adjusting system 4 without providing any applied force according to a second preferred embodiment of the present invention. The difference between the first preferred embodiment and the second preferred embodiment is that the first characteristic gap W₁ and the second characteristic gap W₂ can be adjusted simultaneously by the adjusting unit 33 in the second preferred embodiment while the adjusting unit 33 is configured to adjust only the first characteristic gap W₁ in the first preferred embodiment. When the second resilient unit 32 is compressed in advance to form a third preset deformation y₃ by an internal force provided from the adjusting unit 33, the length of the first characteristic gap W₁ is shorter than d₃−d₂ if the third prior deformation y₃ is the value between d₁ and d₂. Therefore, only if the applied force is larger than k₂(d₁−y₃), could the output force be induced from the first resilient unit 31 and the second resilient 32.

FIG. 5 schematically illustrates the adjusting device 5 without providing any applied force according to a third preferred embodiment of the present invention. In fact, the third preferred embodiment is a special case of the second preferred embodiment. Since the second resilient unit 32 is connected with the adjusting unit 33, the second characteristic gap W₂ is zero permanently. When the second resilient unit 32 is compressed in advance to form a forth preset deformation y₄ by an internal force provided from the adjusting unit 33, wherein the forth preset deformation y₄ is less than the first original length d₁, the length of the first characteristic gap W₁ is decreased. Hence, the output force could be induced from the first resilient unit 31 and the second resilient unit 32 by the applied force which must be larger than k₂(d₁−y₄). When the second resilient unit 32 is stretched in advance to form the forth preset deformation y₄, the length of the first characteristic gap W₁ is adjusted to be longer. Therefore, only when the applied force is larger than k₂(y₄+d₁), could the output force be induced from the first resilient unit 31 and the second resilient unit 32.

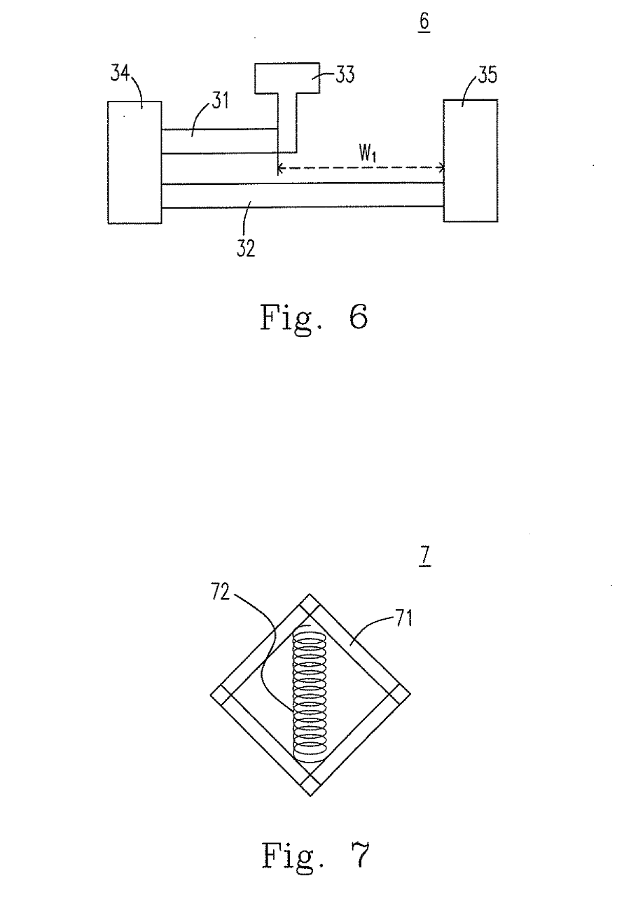

FIG. 6 schematically illustrates the adjusting device 6 without providing any applied force according to a forth preferred embodiment of the present invention. In fact, the forth preferred embodiment is a special case of the first preferred embodiment. The second resilient unit 32 is connected with the second unit 35 to be a connecting resilient unit and has a length being a sum of lengths of the first resilient unit 31 and the first characteristic gap W₁ so that the second characteristic gap W₂ is zero permanently. When the first resilient unit 31 is stretched in advance to form a fifth preset deformation y₅ by an internal force provided from the adjusting unit 33, wherein the fifth preset deformation y₅ is less than the first original length d₁, the length of the first characteristic gap W₁ is decreased. Hence, the output force could be induced from the first resilient unit 31 and the second resilient unit 32 by the applied force which must be larger than k₂(d₁−y₅). When the first resilient unit 31 is compressed in advance to form a fifth preset deformation y₅, the length of the first characteristic gap W₁ is adjusted to be longer. Therefore, the output force could be induced from the first resilient unit 31 and the second resilient unit 32 by the applied force which must be larger than k₂(y₅+d₁).

The order of the first characteristic gap W₁, the adjusting unit 33 and the first resilient unit can be arbitrarily changed in the above preferred embodiment. Similarly, the order of the second characteristic gap W₂, the adjusting unit 33, and the second resilient unit 32 can also be arbitrarily changed. If the adjusting device could be preformed, the order would be changed arbitrarily.

The first resilient unit and the second resilient unit can be an elastic matter such as a spring, or a nonlinear resilient body such as a four-bar mechanism having a linear spring. FIG. 7 schematically illustrates the four-bar mechanism. Since the spring 72 is connected with the four bar mechanism 71 and a force direction of the spring 72 is intersected with a force direction of the nonlinear resilient body, the output force performance of the nonlinear resilient body would be non-linear. Therefore, the output force performance of the adjusting system can be changed arbitrarily by using different kinds of resilient unit.

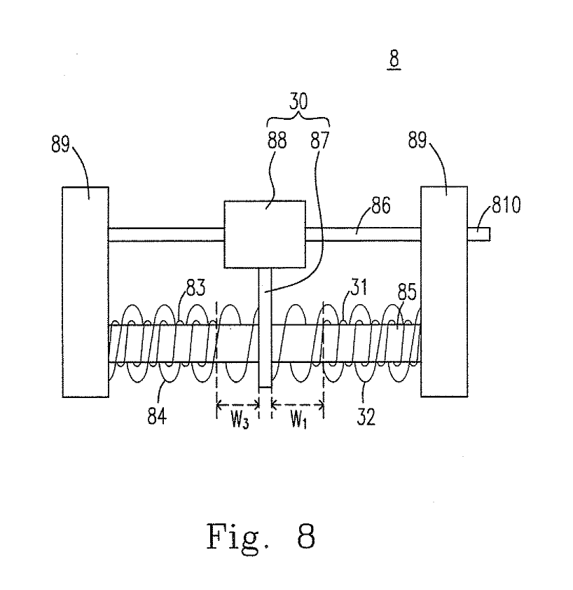

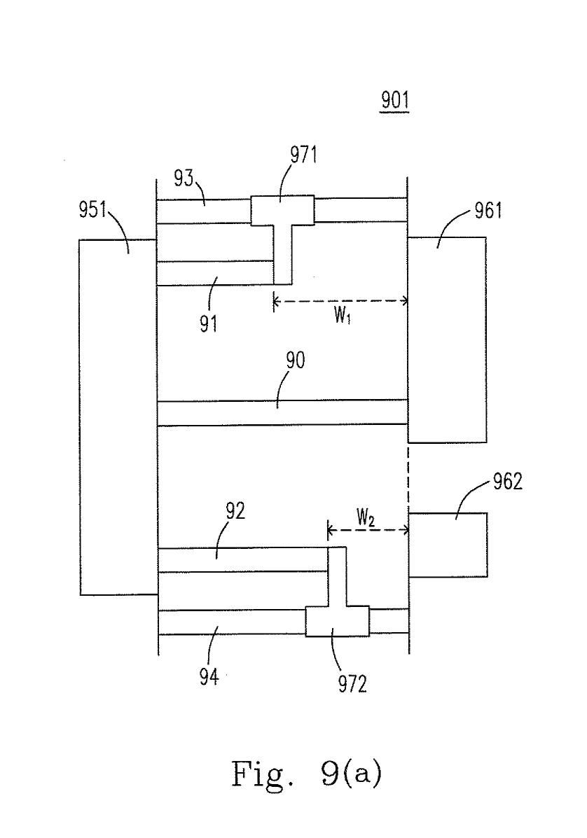

FIG. 8 schematically illustrates the adjusting system 8 without providing any applied force according to a fifth preferred embodiment of the present invention. The adjusting system 8 further includes a first resilient unit 31, a second resilient unit 32, a first characteristic gap W₁ having a first original length d₁, a second characteristic gap W₂ having a second original length d₂ and an adjusting unit 30, wherein the adjusting unit 30 further includes a movable unit 87 and a force controller 88 connecting with each other. In addition, the first resilient unit 31 and the second resilient unit 32 are penetrated by a first screw 85 and the movable unit 87 can be moved thereon to adjust the first characteristic gap W₁ and the second characteristic gap W₂. Since the second resilient unit 32 is touched the adjusting unit 30 but is not connected therewith, the second original length d₂ is zero. Moreover, the adjusting system 8 further includes a third resilient unit 83, a forth resilient unit 84, a third characteristic gap W₃ having a third original length d₃ and a forth characteristic gap W₄ having a forth original length d₄. The third resilient unit 83 and the forth resilient unit 84 are also penetrated by a first screw and used for the same purpose, and the forth original length d₄ is zero since the forth elastic unit 84 is touched the adjusting unit 30 but is not connected therewith. The force controller 88 is configured on a second screw 86 to move thereon and provides the internal force to move the movable unit 87 for adjusting the first characteristic gap W₁, the second characteristic gap W₂, the third characteristic gap W₃ and the forth characteristic gap W₄. In addition, the first screw 85 and the second screw 86 are fixed by a spring holder 89.

Please refer to FIG. 8, when the movable unit 87 is moved right by the internal force provided from the force controller 88, the second resilient unit 32 would be compressed by the movable unit 87 to adjust first characteristic gap W₁ so that the applied force to compress the first resilient unit 31 would become smaller. In addition, the length of the third characteristic gap W₃ and the forth characteristic gap W₄ would be lengthened so that the third resilient unit 83 and the forth resilient unit 84 would not be stretched. When the movable unit 87 is moved left by the internal force provided from the force controller 88, the forth resilient unit 84 would be compressed by the movable unit 87 to adjust third characteristic gap W₃ so that the applied force to compress the third elastic unit 83 would become smaller. In addition, the length of the first characteristic gap W₁ and the second characteristic gap W₂ would be lengthened so that the first resilient unit 31 and the second resilient unit 32 would not be stretched. Therefore, there is a changeable stiffness in the adjusting system whether the internal force and the applied force are provided to move the movable unit 87 right or left. In addition, when the internal force and the applied force are released, the first resilient unit 31, the second resilient unit 32, the third resilient unit 83 and the forth resilient unit 84 could buffer themselves against the impact.

In general, the adjusting system further includes an input unit and an output unit. For example, please refer to FIG. 8, the input unit can be an input terminal 710 configured on the right sides of the second screw 76 to provide a torsional force to move the movable unit 87. In addition, the output unit can be an output mechanism (not showed) configured outside the adjusting device to provide an output force therefrom. In fact, the adjusting system should not be limited that there are only two resilient units therein. Therefore, a plurality of resilient units can be added into the adjusting system to increase the variance in the stiffness thereof and a plurality of adjusting units corresponding to the plurality of resilient units can also be added to adjust at any time to provide appropriate stiffness.

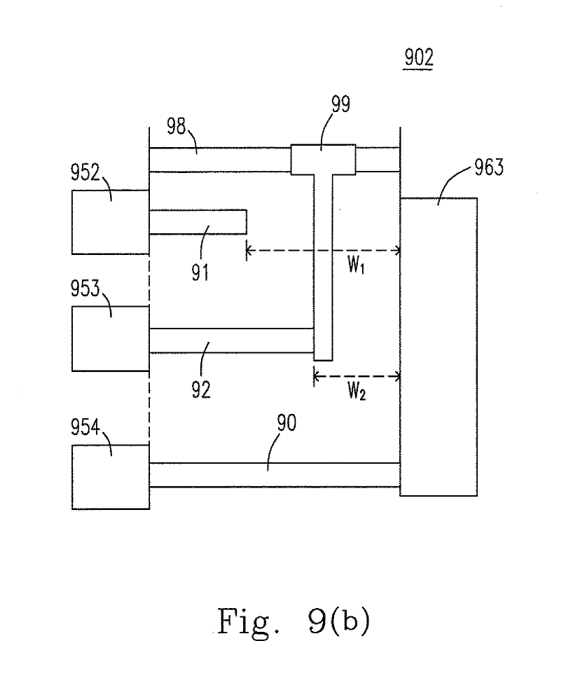

FIGS. 9 (a) and (b) schematically illustrates the actuator 901, 902 without providing any applied force according to sixth and seventh preferred embodiments of the present invention. The actuator includes a first resilient unit 91, a second resilient unit 92, a third resilient unit 90, a first characteristic gap W₁, a second characteristic gap W₂ and a third characteristic gap W₃, wherein the length of the third characteristic gap W₃ is zero permanently. The first characteristic gap W₁ and the second characteristic gap W₂ are adjusted by a first adjusting unit 971 and a second adjusting unit 972 respectively in FIG. 9(a), wherein the first adjusting unit 971 and the second adjusting unit 972 are respectively configured on a first screw 93 and a second screw 94 to move thereon. The first characteristic gap W₁ and the second characteristic gap W₂ are adjusted by a third adjusting unit 99 simultaneously in FIG. 9(b), wherein the third adjusting unit 99 is configured on a third screw 98 to move thereon. When there are four resilient units in the actuator, the operating method can be that three characteristic gaps are adjusted respectively by three adjusting units, a characteristic gap and the other characteristic gaps are adjusted respective by two adjusting units, or three characteristic gaps are adjusted simultaneously by an adjusting unit. When there are more than four resilient units in the adjusting device, the operating method can be derived from the aforementioned method. Therefore, a plurality of resilient units with a plurality of characteristic gaps and a plurality of adjusting units can be added into the actuator to provide appropriate stiffness.

The actuator includes a power input unit connected one end of the plurality of resilient units and a power output unit connected the other end of the plurality of resilient units. Therefore, an input force is provided from the power input unit, and an output force is induced by the power output unit. If the output force which is demanded is too huge so that a power input unit can not provide enough input force to the actuator, the input force can be provided by a plurality of power input units, each of which connects one end of the at least one respective resilient unit. If the input power is too huge so that the power output unit will be provided too much output force from the actuator, the output force can be divided by adding a plurality of power output units each of which connects one end of the at least one respective resilient unit.

Please refer to FIG. 9(a), there are a first power input unit 951 corresponding to the first resilient unit 91, the second resilient unit 92 and the third resilient unit 90, a first power output unit 961 corresponding to the first resilient unit 91 and the second resilient unit 92 and a second power output unit 962 corresponding to the third resilient unit 90. Please refer to FIG. 9(b), there are a second power input unit 952 corresponding to the first resilient unit 91, a third power input unit 953 corresponding to the second resilient unit 92, a forth power input unit 954 corresponding to the third resilient unit 90 and a third power output unit 963 corresponding to the first resilient unit 91, the second resilient unit 92 and the third resilient unit 90. According to the above descriptions, the actuator can also include a plurality of power input unit and a plurality of power output unit simultaneously.

Based on the above descriptions, it would be understood in the present invention that the output power performance could be adjusted according to the demand which has been known and the demand which has been changed. This can provide a system with changeable stiffness to actively or passively adjust the output power performance.

While the invention has been described in terms of what are presently considered to be the most practical and preferred embodiments, it is to be understood that the invention should not be limited to the disclosed embodiment. On the contrary, it is intended to cover numerous modifications and variations included within the spirit and scope of the appended claims which are to be accorded with the broadest interpretation so as to encompass all such modifications and variations. Therefore, the above description and illustration should not be taken as limiting the scope of the present invention which is defined by the appended claims.

What is claimed is:

1. An adjusting system with a least one characteristic gap, comprising:
a first unit;
a second unit;
at least one resilient unit having a first end coupled to one of the first and the second units and a second end, wherein the at least one characteristic gap is a distance between the second end and the other one of the first and the second units; and
an adjusting unit configured to adjust the at least one resilient unit to change the at least one characteristic gap.

2. The adjusting system as claimed in claim 1, wherein the first unit is an input unit and the second unit is an output unit.

3. The adjusting system as claimed in claim 1, wherein the adjusting unit is connected with the at least one resilient unit.

4. The adjusting system as claimed in claim 1, wherein the adjusting unit further comprises:
a movable unit; and
a force controller connected with the movable unit.

5. The adjusting system as claimed in claim 4, wherein the movable unit is configured to adjust the at least one characteristic gap by a force provided from the force controller.

6. The adjusting system as claimed in claim 1, wherein the at least one resilient unit is one of a spring and a nonlinear resilient body.

7. The adjusting system as claimed in claim 6, wherein the nonlinear resilient body further comprises a spring and a four-bar mechanism, the spring is connected with the four-bar mechanism, and a force direction of the spring is intersected with a force direction of the nonlinear resilient body.

8. The adjusting system as claimed in claim 1, wherein the adjusting unit is configured to adjust a stiffness of the adjusting system.

9. The adjusting system as claimed in claim 1 further comprising a connecting resilient unit connecting the first and the second units.

10. An actuator with a plurality of characteristic gaps, comprising:
a plurality of resilient units, each of which has two ends and a respective characteristic gap outside one end thereof; and
a plurality of adjusting units, each of which adjusts at least a respective one of the plurality of characteristic gaps.

11. The actuator as claimed in claim 10 further comprising a power input unit connecting one end of each the resilient units.

12. The actuator as claimed in claim 10 further comprising a power output unit connecting one end of each the resilient units.

13. The actuator as claimed in claim 10 further comprising a plurality of power input units, each of which connects one end of the at least one respective resilient units.

14. The actuator as claimed in claim 10 further comprising a plurality of power output units, each of which connects one end of the at least one respective resilient units.

15. The actuator as claimed in claim 10, wherein each of the plurality of adjusting units further comprises:
a movable unit; and
a force controller connected with the movable unit.

16. The actuator as claimed in claim 15, wherein the movable unit is configured to adjust at least one respective characteristic gap by a force provided from the force controller.

17. The adjusting device as claimed in claim 10, wherein at least one of the plurality of characteristic gaps has a length larger than zero.

18. An adjusting device coupled between two units, comprising:
a resilient unit having a first end connecting one of the two units and a second end, wherein between the second end and the other one of the two units, there is a characteristic gap; and
an adjusting unit adjusting the characteristic gap.

19. The adjusting device as claimed in claim 18 further comprising a movable unit configured to carry thereon the adjusting unit.

20. The adjusting device as claimed in claim 19 further comprising a connecting resilient unit connecting the two units, and having a length being a sum of lengths of the resilient unit and the characteristic gap.
